(19) United States
(12) Patent Application Publication
(10) Pub. No.: US 2002/0098860 A1
(43) Pub. Date: Jul. 25, 2002

(54) Transmit power control method and apparatus

(76) Inventors: Mark E. Pecen, Palatine, IL (US); Donald A. Dorsey, Vernon Hills, IL (US)

Correspondence Address: MOTOROLA, INC., 1303 EAST ALGONQUIN ROAD, IL01/3RD, SCHAUMBURG, IL, 60196

(21) Appl. No.: 10/102,487

(22) Filed: Mar. 20, 2002

Related U.S. Application Data
(63) Continuation-in-part of application No. 09/229,144, filed on Jan. 12, 1999.
(63) Continuation of application No. 09/397,835, filed on Sep. 17, 1999, now abandoned.

(51) Int. Cl. H04Q 7/20

(52) U.S. Cl. 455/522; 455/456

(57) ABSTRACT

A communication system includes grouping a plurality of mobile stations into a plurality of groups of mobile stations, and assigning a power control range to each group of the plurality of groups of mobile stations, thereby, creating a plurality of power control ranges corresponding to the plurality of groups of mobile stations. Each power control has a minimum and maximum power level. As such, in GPRS mode, all mobile stations with multi-slot-classes that share at least one common time slot and are located in proximity of each other with similar downlink power control requirement may be assigned a power control range for adequate downlink signal reception. The mobile stations grouped in one group are required to monitor all time slots defined in their multi-slot-class for detection of data in the USF field or data field.

### CROSS-REFERENCE TO RELATED APPLICATION

This application is a continuation-in-part of U.S. patent application Ser. No. 09/229,144, filed Jan. 12, 1999 and a continuation of U.S. patent application Ser. No. 09/397,835, filed Sep. 17, 1999.

### RELATED FIELD OF THE INVENTION

The present invention relates to the field of communication systems, and more particularly, to transmit power control techniques in a communication system.

### BACKGROUND OF THE INVENTION

A frequency planning among closely located base stations in a communication system may be used such that the co-channel interference is minimized. For example, referring to FIG. 1, a base station 110 according to a frequency planning tries not to transmit at the same time on the same frequency as a base station 101 is transmitting. Such frequency planning minimizes co-channel interference. As such, for example, mobile stations 131 and 132 each communicating with different base stations experience minimal co-channel interference, however, co-channel interference is not entirely eliminated when base stations are not time synchronized. Two closely located base stations may for short period of time transmit on the same frequency.

To further minimize co-channel interference, in addition to a frequency planning, each base station utilizes a power control scheme to minimize transmission of signals thus limiting the power level. The level of interference on an RF channel normally is associated with the sum of the contributions from multiple RF transmitting sources. As such, controlling radio frequency (RF) power level minimizes the amount of the signal power level on a radio link to a level needed for an adequate communication quality. Power control in effect reduces the average amount of RF spectral energy surrounding the mobile and base stations, thus reducing the level of interference. The power control scheme may be implemented on downlink signals, transmitted from the base stations to the mobile stations, and uplink signals, transmitted from the mobile stations to the base stations.

Power control of radio frequency signals transmitted from different sources in a communication system in different forms are known. The concept of power control is normally based on a feedback system. In particular, the specification for a Global System for Mobile Communications (GSM) communication system describes a method for controlling power level of downlink signals. GSM utilizes power control of mobile and base stations. Referring to FIG. 1, a communication system 100 employing a form of power control technique is shown. Such power control scheme may be according to the GSM standards. The communication system 100 may include one or more base stations such as base stations 101 and 110, each working independently providing communication services to a number of mobile stations, such as mobile stations 130-34. At different times, the number of mobile stations located in a geographic area receiving communication services may vary, although in this example only five mobile stations are shown. The communication services may be provided according to a commonly known method of communication such as Time Division Multiple Access (TDMA) as described in the specification for the GSM system. Each mobile station communicates with a base station through down and uplink signals. The uplink signals 141-45 have respectively associated downlink signals 151-55.

For downlink RF power control, a base station receives from each mobile station, in communication with the base station, information or a report about quality of the signals received at each mobile station. Such information may include a quality of signal indicator and downlink signal power level received at each mobile station. For example, the information received at 180 and 181 are compared to thresholds 190 and 191 by comaprators 193 and 192 respectively at base stations 110 and 101. Based on the comparison, downlink signal power level associated with the mobile station that reported the information is increased or decreased accordingly. Each downlink signal normally is controlled independently. The GSM specifications also define a power control for uplink RF signals which is dependent on the power output class of the mobile stations.

In a General Packet Radio Services (GPRS) mode, a GSM system may include at least one broadcast control channel (BCCH) and a number of downlink physical data channels (PDCH) providing communication services to the mobile stations. The BCCH is broadcast at fixed power level for all mobile stations in the coverage area. As such, the BCCH channel normally is transmitted at the maximum power level allowable by the base station. The downlink power on the PDCH is limited by the GSM specifications to 10 dB below a certain reference level, commonly referred to “P0” level. The information regarding P0 is sent to the mobile stations in an assignment message. The base station after sending the value of P0 to a mobile station, should ensure that the downlink PDCH intended for that mobile station is transmitted at a power level between a range of power levels defined by a maximum and minimum power levels. The maximum and minimum power levels are calculated respectively according to (BCCH carrier level—P0) and (BCCH carrier level—P0—10 dB). The P0 value is used until the temporary block flow (TBF) in which the assignment message refers terminates or another assignment message is sent to the mobile station which re-assigns the value of P0. Depending on the downlink signal propagation condition between the base station and the mobile station, a new TBF message may be sent to the mobile station to correct for differences in the signal propagation at different times. The P0 parameter allows the mobile stations with limited received signal dynamic range some advance knowledge of how to set their receiver automatic gain control preventing a receiver signal overload.

FIG. 2 is a graphical representation of maximum and minimum power levels of a downlink signal received at a mobile station for a P0 value with respect to the free space distance between the mobile station and a base station. As shown in FIG. 2, a range of signals received at a mobile station close to the base station, for example, 1 mile away in free space, is between −75 to −85 dBm. For a mobile station 7 miles away from the base station, for example, the range is between −95 to −105 dBm. Therefore, the P0 value must be different for the mobile station 7 miles away from the base station than for the mobile station 1 mile away. Furthermore, environmental conditions at different areas may drastically change the propagation path loss characteristics such that two mobile stations close to the base station may require two different P0 values. The value of P0 parameter is determined according to the signal quality received at the base station. The TBF assignment message is used to change P0 value when signal quality drops below a threshold.

The communication services provided by a communication system, such as communication system 100, may include communication of voice and data services. GPRS is a feature of the GSM system for the purpose of communicating data, i.e. non-voice, between mobile stations and base stations. The standards for communicating data are according to a form of packet switched communication as explained in the GSM standards, a copy of the specification may be obtained by contacting ETSI, F-06921 Sophia Antipolis Cedex-FRANCE, or accessing the web site for ‘etsi.org’ on the internet. An important part of GPRS standard may include providing communication of data service to more than one mobile station in a GPRS mode. For example, base station 101 may be in GPRS mode communication with mobile stations 130 and 131. When communication with a mobile station is in a GPRS mode, that is, a packet switched mode, the base station may transmit data to the mobile station on a few time slots until data transfer is completed.

To begin a data transfer via packet data switching in a GPRS mode, the mobile station and base station go through a series of setup sequences exchanging necessary information for data transfer to begin. Once the data transfer is completed, the mobile station and base station go through a teardown sequence to terminate the data transfer. During the data transfer period, the base station may transmit data to the mobile station on a downlink signal on a series of time slots that were previously assigned by the base station and communicated to the mobile station. In another way, the base station may dynamically allocate a series of time slots on the downlink to transfer an entire block of data to the mobile station. There may be more than one block of data to be transmitted during the data transfer period. Each block of data is interleaved across four TDMA frames with a portion of the data sent on one time slot in each of the four frames. The time slots in dynamic allocation mode are selected from a series of time slots predefined according to the mobile station “multi-slot-class” information communicated between the base station and mobile station.

After a setup sequence, each mobile station normally monitors the time slots defined by the base station. The slots are selected from the mobile station multi-slot-class. Two or more mobile stations may have multi-slot-classes that are either the same or share at least one common time slot. As a result, two or more mobile stations may be monitoring the same time slots for receiving downlink information. For example, there may be at least 29 different multi-slot-classes. A mobile station belonging, for example, to a multi-slot-class 24 may be required to monitor all time slots from the first time slot to the eighth time slot in a time frame consisting of essentially 8 time slots. A mobile station belonging, for example, to multi-slot-class 3, may be required to monitor all time slots from the first time slot to the second time slot. Mobile stations in communication with a base station normally operate according to a time synchronization as defined by the base station. Therefore, two or more mobile stations in communication with the same base station may be monitoring the same time slot for detecting and receiving downlink information. The data is tagged such that it identifies the intended mobile station.

In dynamic allocation mode, a block of data may be transferred to a mobile station over four time slots in four consecutive TDMA frames. The downlink signal at each time slot selected for transmission of a block of data is required to have the same power level. Thus, all four time slots selected for transmission of a block of data intended for a mobile station are transmitted at the same power level.

Data in each time slot may have at least two data fields. For example, FIG. 3 is a block diagram of an exemplary time slot 300 that includes two data fields 302, 304. A first data field 302 may contain an uplink status flag (USF), followed by a second data field 304 containing data of the block of data. Each mobile station has a unique identification associated with the data bits in USF field 302. To give an immediate uplink access to a mobile station, the base station places the USF identity of a mobile station in USF field 302 to give that mobile station an immediate access to an uplink time slots. If the value of the USF bits is the same as the value assigned to a mobile station then the mobile station, after detecting the USF bits, may transmit on uplink on the same time slot of the next frame that received the USF field. The mobile station decides whether to transmit according to the allowed time slots. The mobile station identified by USF field 302 may be different than the mobile station for which data field 304 is intended. Due to the fact that mobile stations with common multi-slot-class are monitoring all time slots in the class, it is possible that the USF field 302 may be intended for one mobile station and data field 304 for another mobile station in one time downlink time slot.

The environments through which downlink signals propagate may be entirely different for each mobile station. Mobile stations, although close in proximity, may receive signals transmitted from a base station at entirely different power levels because, for example, an obstacle such as a building obstructs one mobile station's line of sight. Such mobile stations, while monitoring the time slots as defined by their multi-slot-class, may require different downlink signal power levels. When a downlink signal is transmitted to a mobile station, the power control feedback loop may set the power level necessary for adequate reception at the intended mobile station. As a result, the P0 value set for a mobile station intended to receive the USF field data may be different than the P0 value of another mobile station for which the data field is intended.

In GPRS mode, all mobile stations with multi-slot-classes that share at least one common time slot may require different power levels for adequate reception. Since such mobile stations are required to monitor all time slots defined in their multi-slot-class for detection of USF field data or data field data, some mobile stations may experience difficulty detecting the data transmitted during such time slots. Some mobile stations, depending on their locations or carrier-to-inference levels with different downlink power level requirements, may experience difficulty detecting the USF data that are tagged along with the data intended for another mobile station.

Therefore, there is a need for a power control scheme applied over the downlink signals such that USF data intended for one mobile station and data field data intended for another mobile station are adequately received at both mobile stations.

### BRIEF DESCRIPTION OF THE DRAWINGS

FIG. 1 depicts a communication system employing a power control scheme of the prior art for downlink signals transmitted to mobile stations.

FIG. 2 is a graphical representation of maximum and minimum power levels of a downlink signal received at a mobile station in the communication system of FIG. 1.

FIG. 3 is a block diagram of an exemplary time slot.

FIG. 4 is a block diagram of a communication system in accordance with an embodiment of the present invention.

FIG. 5 is a graphical representation of exemplary maximum and minimum downlink signal power levels assigned to each group of mobile stations of FIG. 3 in accordance with an embodiment of the present invention.

FIG. 6 is a logic flow diagram of steps executed by the base station of FIG. 3 in implementing the zoning of downlink power control range in accordance with an embodiment of the present invention.

FIG. 7 is a logic flow diagram of steps executed by the base station of FIG. 3 in managing the power control zones in accordance with an embodiment of the present invention.

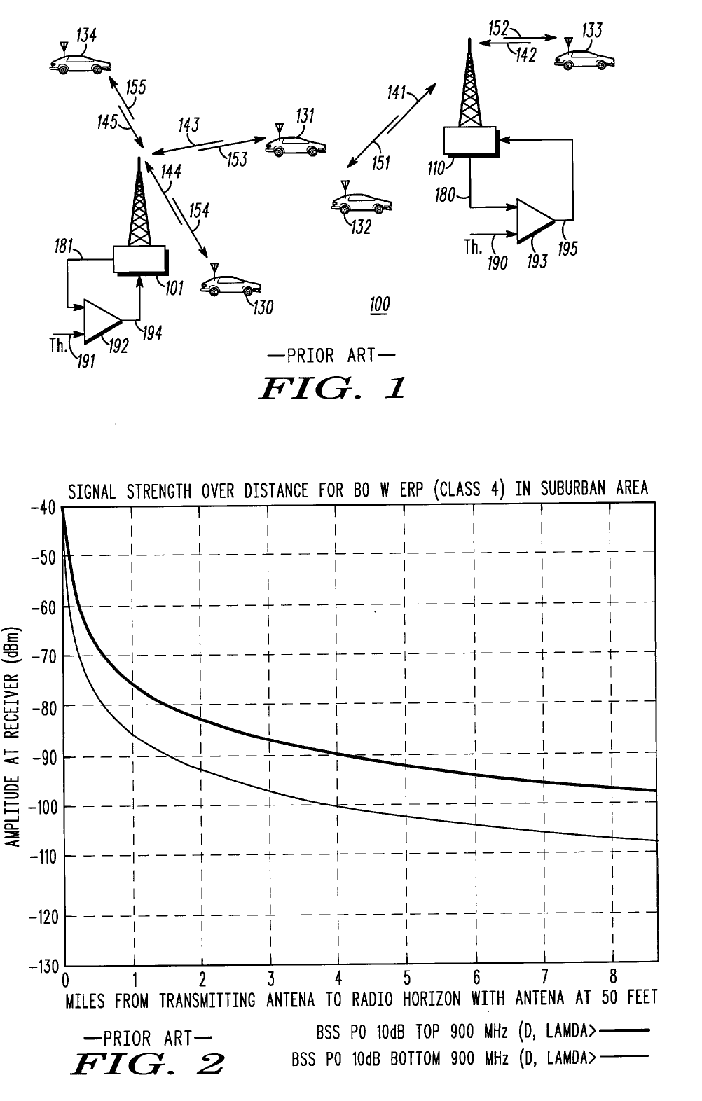

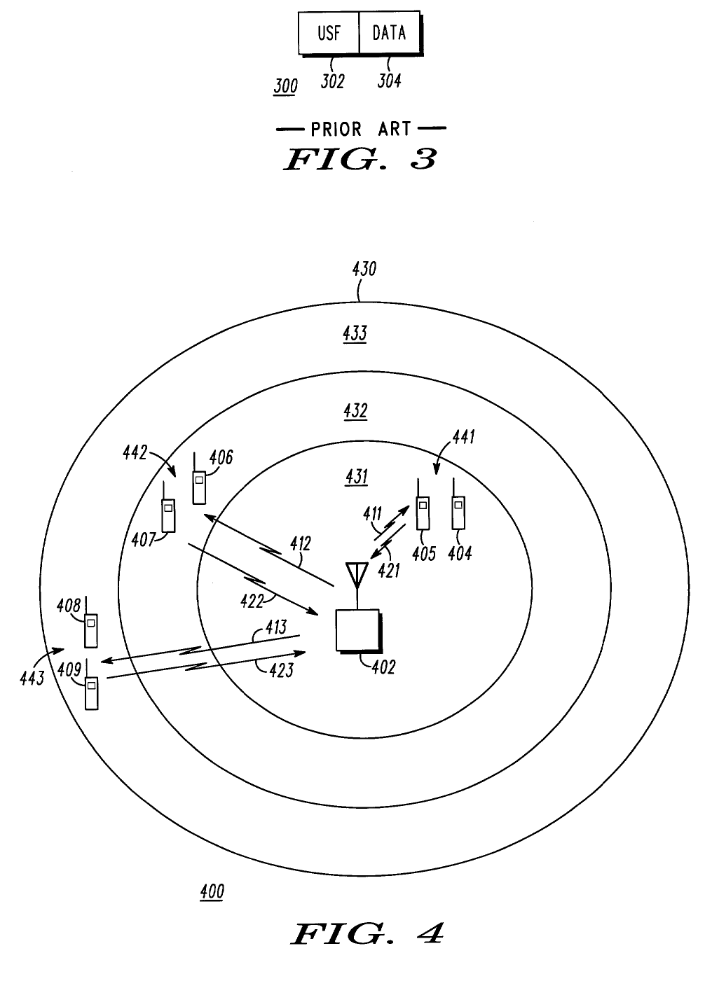

### DETAILED DESCRIPTION OF THE PREFERRED EMBODIMENT(S)

According to various aspects of the invention, in a communication system, a method may include grouping a plurality of mobile stations into a plurality of groups of mobile stations, and assigning a power control range to each group of the plurality of groups of mobile stations, thereby creating a plurality of power control ranges corresponding to the plurality of groups of mobile stations. Each power control range has a minimum and maximum power level. As such, in GPRS mode, all mobile stations with multi-slot-classes that share at least one common time slot and are located in proximity of each other with similar downlink power control requirement may be assigned a power control range for adequate downlink signal reception. The mobile stations grouped in one group are required to monitor all time slots defined in their multi-slot-class for detection of data in the USF field or data field. The mobile stations grouped in one group each having a multi-slot class that shares at least one time slot may not experience difficulty detecting the data or the USF data transmitted during such time slots. According to an aspect of the invention, at least a downlink signal transmitted from a base station to at least one of the plurality of mobile stations is controlled according to one of the plurality of power control ranges corresponding to one of the plurality of groups of mobile stations that includes the least one of the plurality of mobile stations.

FIG. 4 is a block diagram of a communication system 400 in accordance with an embodiment of the present invention. Communication system 400 includes a base station 402 that provides communications services to each of multiple mobile stations 404-409 (six shown) located in a coverage area 430 serviced by the base station. In order to optimize the power level of the uplink and downlink signals exchanged between base station 402 and each of mobile stations 404-409, communication system 400 divides coverage area 430 into multiple power control ranges or power control zones 431-433 (three shown) and assigns a downlink signal power range to each power control zone. The multiple mobile stations 404-409 may then be thought of as being grouped into multiple mobile station groups 441-443, for example, mobile station group 441 comprising mobile stations 404-405, mobile station group 442 comprising mobile stations 406-407, and mobile station group 443 comprising mobile station 408-409, wherein each mobile station group of the multiple mobile station groups 441-443 corresponds to a power control zone of the multiple power control zones 431-433. Each mobile station 404-409 then communicates with base station 402 via a downlink signal 411-413 and an uplink signal 421-423 associated with one or more of the mobile stations in the group to which the mobile station belongs.

The assignment of a power control range to a power control zone 431-433 may be based on determining location of at least one of the multiple groups of mobile stations 441-443 with respect to base station 402. The grouping of the mobile stations 404-409 may, in turn, be based on determining location of the mobile stations with respect to base station 402. The assignment and groupings may alternatively or additionally be based on the downlink signals reception quality at the multiple mobile stations. The assignment of power control ranges may include assigning a power level reference value, such P0, to each of the multiple power control ranges. The multiple power control ranges may be communicated by base station 402 to corresponding groups of mobile stations 441-443. Such communication may include communicating the assigned power reference value to the mobile stations 404-409 in each group 441-443.

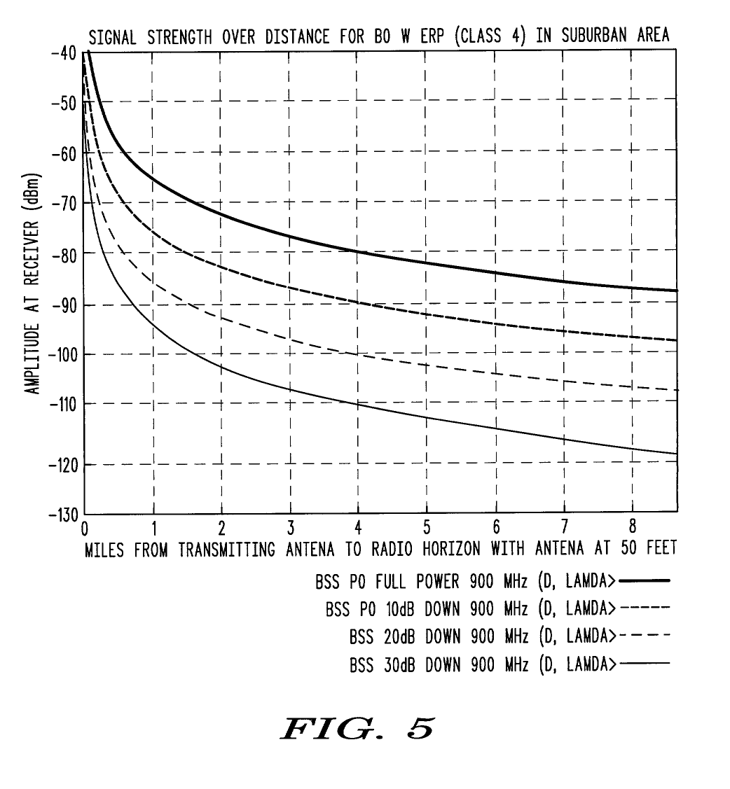

FIG. 5 is a graphical representation of exemplary maximum and minimum downlink signal power levels assigned to each group of mobile stations 441-443 in accordance with an embodiment of the present invention. In one embodiment of the present invention, depending on the distance of each mobile station 404-409 from the base station 402, a different power control range may be assigned. For example, for mobile stations located at about 4-8 miles from the base station 402, an associated power control range may be limited to a power control range limited by the solid line shown in FIG. 5 and a lower value. For mobile stations located between 1.5 to 4 miles from the base station 402, an associated power control range may be limited to a power control range limited by the dotted line below the solid line shown in FIG. 5 and a lower value. Similarly for other mobile stations 404-409. Another example of a zoned system for allocating power among multiple groups of mobile stations is described in detail in U.S. patent application Ser. No. 09/229,114, attorney docket number CS10114, entitled “Automatic Gain Control for a Receiver and Method Therefor,” which application is assigned to the assignee of the present invention and is incorporated by reference herein in its entirety. Application Ser. No. 09/229,114 discloses power control techniques for GPRS mode in a GSM communication system that includes a coverage area divided into multiple zones. The zones can be selected according to a distance of mobile station from the base station, and each zone has maximum and minimum power levels assigned to the group of mobile stations located in the zone.

The power control ranges 431-433 may be viewed as zones of power control. The ranges, or zones, 431-433 may be dynamic, such that power control ranges change depending on the communication system conditions. Some hysteresis between zones 431-433 may be created to eliminate rapid reassignment of zones to mobile stations 404-409. A mobile station 404-409 may be acceptable to be grouped into more than one zone 431-433. Power control ranges, that is, zones, 431-433 may be adaptive in the event that much of the GPRS traffic is prevalent in an area. Some groups of mobile stations 441-443 in GPRS mode may be within a certain distance from the base station 402 antenna. In the case of areas of high population density using GPRS services, a zone 431-433 may be dynamically created to absorb the high population density.

By dividing a coverage area 430 up into power control ranges, or power control zones, 431-433, as the GPRS traffic is increased on the system, the problems with having to manage the transmit power level such that the downlink signal is suitable for more than one mobile station in which at least one mobile station is at a vastly differing distance from the base station antenna are greatly reduced.

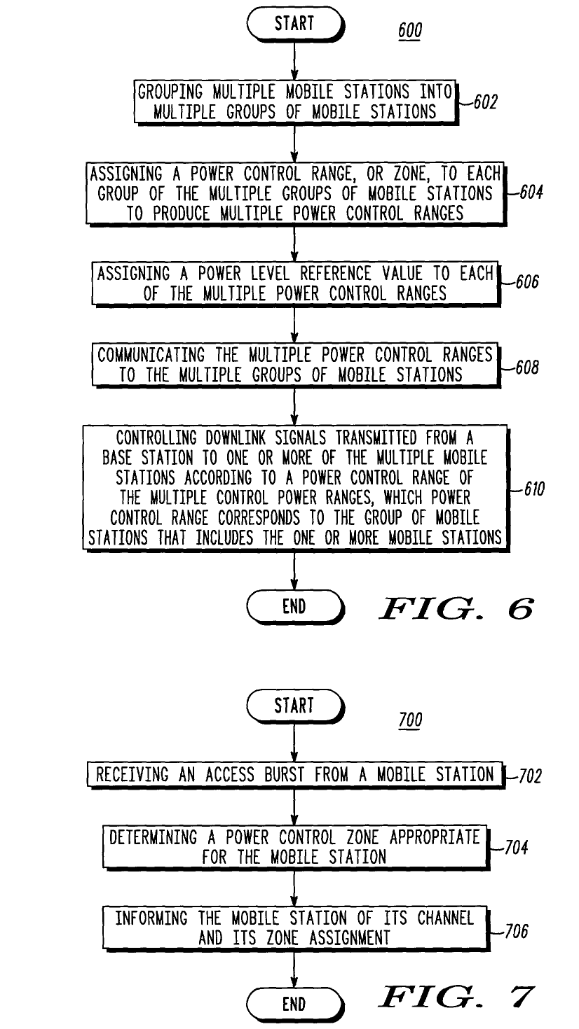

FIG. 6 is a logic flow diagram 600 of steps executed by base station 402 in implementing the zoning of downlink power control range in accordance with an embodiment of the present invention. A software algorithm or hardware in base station 402 implements the zoning of downlink power control range by dynamically creating and eliminating the power control zones, that is, power control ranges 431-433. Another algorithm implements assignment to a mobile station 404-409 of a new zone 431-433 when the mobile station crosses the boundary from one zone to another. The power control zones 431-433 are based upon carrier-to-interference and received power levels reported by the mobile station and are of a logical nature, and may or may not be directly related to the distance between the mobile station 404-409 and base station 402. Nevertheless, there may be exceptions to the path loss characteristics being a strict function of distance between the mobile station and base station 402 antennas. There may exist conditions in which a mobile station 404-409 is located near a base station 402 antenna, but located inside a structure having a high amount of radio frequency (RF) signal absorption. The timing advance of the communication between the base station and such closely located mobile station may indicate that the mobile station is nearby, but the carrier-to-interference and received power information reported by the mobile would cause the base station to assign the mobile to a zone which may contain other mobiles which are much farther away, but logically within the same power control zone or range.

Logic flow diagram 600 begins when base station 402 groups (602) the multiple mobile stations 404-409 into multiple groups of mobile stations 441-443. In one embodiment of the present invention, the grouping is based on determining a location of each of the multiple mobile stations 404-409 with respect to the base station 402 providing communication services to said plurality of mobile stations. Base station 402 then assigns (604) a power control range to each group of the multiple groups of mobile stations 441-443, thereby creating multiple power control ranges 431-433 corresponding to the multiple groups of mobile stations 441-443, wherein each power control has a minimum and maximum power level. As a result, in one embodiment of the present invention, the assignment of a power control range is based on determining a location of at least one of the multiple groups of mobile stations 441-443 with respect to the base station 402. In other embodiments of the present invention, as described above, the groupings may be based on reception quality such as carrier-to-interference and/or received power information reported by the mobile. The assignment of a power control range to a group of mobile stations 441-443 may then additionally, or alternatively, be based on reception quality of at least a respective downlink signal 411-413 transmitted to at least one of the mobile stations in the group. Base station 402 may also assign (606) a power level reference value to each of the multiple power control ranges 431-433. Base station 402 then communicates (608) the multiple power control ranges to the multiple groups of mobile stations.

In one embodiment of the present invention, multiple mobile stations in a group of mobile stations 441-443 may belong to multiple multi-slot-classes that have at least one common time slot. The multiple mobile stations in the group of mobile stations may then share at least one time slot in a plurality of multi-slot-classes assigned to the group of mobile stations. In another embodiment of the present invention, multiple mobile stations in a group of mobile stations 441-443 may monitor at least a common time slot in a TDMA frame in a downlink signal 414-419 in communication system 100. As described above, the time slot may have at least a first and a second data field 302, 304. The first data field may be intended for a first mobile station of the group of mobile stations, and the second data field is intended for a second mobile station of the group of mobile stations, with the result that a time slot includes data intended for two different mobile stations in the group of mobile stations.

Base station 402 then controls (610) the downlink signals 414-419 transmitted from the base station to each of one or more of mobile stations 404-409 according to a power control range of the multiple power control ranges 431-433, which power control range corresponds to the group of mobile stations of the multiple groups of mobile stations 441-443 that includes the one or more mobile stations for which the downlink signal is intended.

Base station 402 may also eliminate (612) one of the multiple groups of mobile station from the multiple groups of mobile stations. For example, power control ranges or zones 431-433 may be dissolved when they are no longer needed. For example, after a TBF ends, base station 402 may remove the mobile station 404-409 from the existing zone table or list entry. If the mobile station being removed is the last mobile station in the zone 431-433, the zone may be dissolved and the corresponding group eliminated.

FIG. 7 is a logic flow diagram 700 of steps executed by base station 302 in managing the power control zones in accordance with an embodiment of the present invention. The algorithm for managing power control zones may be described in terms of a simplified representation of base station 402 components and the mobile stations 404-409. The signaling plane between a mobile station 404-409 and base station 402 may be with base station zoning logic. Logic flow diagram 700 begins when base station 402 receives (702) an access burst from a mobile station 404-409, which arrives at the base station 302 subsystem via one of the base station transceivers. The base station processes the request by the mobile station to start an uplink or downlink TBF. When base station 402 is ready to grant the assigmnent to the mobile, the base station determines (704) a power control zone appropriate for the mobile station wherein the zoning logic searches a table or list of existing zones and tries to find one that is appropriate for the mobile station based on the mobile station's carrier-to-interference ratio and reported received power level as sent by the mobile in the last Signal Quality Report, or in addition or alternatively based on the location of the mobile station. If no such zone exists, then a logical zone is created in which the optimal carrier-to-interference ratio would be achieved using the minimum of power on the downlink signal. The mobile station is then informed (706) of its channel, and, directly or indirectly, its zone assignment in the assignment message by way of, for example, communication of a P0 value. The mobile stations are not required to have any specially designed software or hardware to operate according to various aspects of the invention. The logic flow then ends.

When base station 402 receives the Channel Quality Report from a mobile station 404-409, the logic which is activated to decode such report in turn activates the zoning logic, which first determines whether the carrier-to-interference ratio is appropriate for the zone 431-433 in which the mobile station is located or the carrier-to-interference information of the mobile station downlink signal 411-413. The algorithm terminates and no reassignment of zone or power control range may occur at an optimal level at which increasing the downlink power would not result in better decoder performance. At such an optimal level, 100% of the transmitted signal would be received at this power level.

If the mobile station 404-409 is assigned to a zone 431-433 but the mobile station's carrier-to-interference ratio is inappropriate for that zone (i.e., either higher than optimal or too low), then the zoning logic searches a table or list of existing zones 431-433 and tries to find a zone that is appropriate for the mobile station based on the mobile station's carrier-to-interference ratio and reported received power level. If no such zone exists, then a logical zone is created in which the optimal carrier-to-interference ratio would be achieved using the minimum of base station power on the downlink signal 411-413. Power control ranges or zones 431-433 may be dissolved when they are no longer needed. After a TBF ends, base station 402 removes the mobile station 404-409 from the existing zone table or list entry. If the mobile station being removed is the last mobile station in the zone 431-433, the zone may be dissolved.

Other communication systems as defined by Enhanced Data for Global Evolution (EDGE) or Enhanced GPRS operate according to similar standards. The present invention may be used in all or any variations of the mentioned data communication systems.

What is claimed is:

1. In a communication system, a method comprising the steps of:
grouping a plurality of mobile stations into a plurality of groups of mobile stations based on signal reception quality;
assigning a power control range to each group of said plurality of groups of mobile stations, thereby creating a plurality of power control ranges corresponding to said plurality of groups of mobile stations, wherein each power control has a minimum and maximum power level.

2. The method as recited in claim 1 further comprising the step of:
controlling at least a downlink signal transmitted from a base station to at least one of said plurality of mobile stations according to one of said plurality of power control ranges corresponding to one of said plurality of groups of mobile stations that includes said least one of said plurality of mobile stations.

3. The method as recited in claim 2 wherein said downlink signal includes a time slot having at least a first and second data fields, wherein said first data field is intended for a first mobile station and second data field for a second mobile station, wherein said first and second mobile stations included in said one corresponding said plurality of groups of mobile stations.

4. The method as recited in claim 1 wherein said assigning is based on determining location of at least one of said plurality of groups of mobile stations with respect to a base station providing communication services to said plurality of groups of mobile stations.

5. The method as recited in claim 1 wherein said grouping is based on determining location of at least one of said plurality of mobile stations with respect to a base station providing communication services to said plurality of mobile stations.

6. The method as recited in claim 1 wherein said assigning includes assigning a power level reference value to each of said plurality of power control ranges.

7. The method as recited in claim 1 further comprising the step of communicating said plurality of power control ranges to corresponding said plurality of groups of mobile stations.

8. The method as recited in claim 1 wherein said plurality of mobile stations in each group share at least one time slot in a plurality of multi-slot classes assigned to the said plurality of mobile stations.

9. The method as recited in claim 1 wherein said assigning is based on reception quality of at least a downlink signal transmitted to at least one of said plurality of mobile stations.

10. The method as recited in claim 1 further comprising the step of eliminating one of said plurality of groups of mobile station from said plurality groups of mobile station.

11. The method as recited in claim 1 wherein said plurality of mobile stations in each group monitor at least a common time slot in a Time Division Multiple Access (TDMA) frame in a downlink signal in said communication system.

12. The method as recited in claim 1 wherein said plurality of mobile stations in each of said plurality of groups belong to a plurality of multi-slot-classes that have at least one common time slot.

13. In a communication system, a method comprising the steps of:
grouping a plurality of mobile stations into a plurality of groups of mobile stations based on a geographical location of each mobile station of the plurality of mobile stations;
assigning a power control range to each group of said plurality of groups of mobile stations, thereby creating a plurality of power control ranges corresponding to said plurality of groups of mobile stations, wherein each power control has a minimum and maximum power level.

14. In a communication system, an apparatus comprising:
means for grouping a plurality of mobile stations into a plurality of groups of mobile stations based on signal reception quality;
means for assigning a power control range to each group of said plurality of groups of mobile stations, thereby creating a plurality of power control ranges corresponding to said plurality of groups of mobile stations, wherein each power control has a minimum and maximum power level.

15. The apparatus as recited in claim 14 further comprising:
means for controlling at least a downlink signal transmitted from a base station to at least one of said plurality of mobile stations according to one of said plurality of power control ranges corresponding to one of said plurality of groups of mobile stations that includes said least one of said plurality of mobile stations.

16. The apparatus as recited in claim 14 further comprising means for determining location, for said means for assigning, of at least one of said plurality of groups of mobile stations with respect to a base station providing communication services to said plurality of groups of mobile stations.

17. The apparatus as recited in claim 14 further comprising means for determining location, for said means for grouping, of at least one of said plurality of mobile stations with respect to a base station providing communication services to said plurality of mobile stations.

18. The apparatus as recited in claim 14 further comprising means for assigning a power level reference value to each of said plurality of power control ranges.

19. The apparatus as recited in claim 14 further comprising means for communicating said plurality of power control ranges to corresponding said plurality of groups of mobile stations.

20. The apparatus as recited in claim 14 wherein said plurality of mobile stations in each group share at least one time slot in a plurality of multi-slot classes assigned to the said plurality of mobile stations.

21. The apparatus as recited in claim 14 wherein said means for assigning bases an assignment on reception quality of at least a downlink signal transmitted to at least one of said plurality of mobile stations.

22. The apparatus as recited in claim 14 further comprising means for eliminating one of said plurality of groups of mobile station from said plurality groups of mobile station.

23. In a communication system, an apparatus comprising:
means for grouping a plurality of mobile stations into a plurality of groups of mobile stations based on a geographical location of each mobile station of the plurality of mobile stations;
means for assigning a power control range to each group of said plurality of groups of mobile stations, thereby creating a plurality of power control ranges corresponding to said plurality of groups of mobile stations, wherein each power control has a minimum and maximum power level.
